(19) United States
(12) Patent Application Publication
(10) Pub. No.: US 2015/0140409 A1
(43) Pub. Date: May 21, 2015

(54) ELECTRICITY STORAGE MODULE AND ELECTRICITY STORAGE CELL

(71) Applicant: HONDA MOTOR CO., LTD., Tokyo (JP)

(72) Inventor: Atsushi SAKURAI, Wako (JP)

(73) Assignee: HONDA MOTOR CO., LTD., Tokyo (JP)

(21) Appl. No.: 14/543,895

(22) Filed: Nov. 18, 2014

(30) Foreign Application Priority Data
Nov. 18, 2013 (JP) 2013-237803

(51) Int. Cl. H01M 2/20; H01M 2/10; H01M 2/30

(52) U.S. Cl. CPC H01M 2/202; H01M 2/305; H01M 2/1077
USPC 429/159; 429/179

(57) ABSTRACT

An electricity storage module includes electricity storage cells. The electricity storage cells are stacked together and each have a positive terminal and a negative terminal. The electricity storage cells include a first electricity storage cell and a second electricity storage cell adjacent to the first electricity storage cell. The positive terminal of the first electricity storage cell is electrically connected to the negative terminal of the second electricity storage cell via a bus bar. The positive terminal and the negative terminal are made of different metals. One terminal and the bus bar are made of a same metal and connected to each other by welding. The one terminal is one of the positive terminal and the negative terminal. Another terminal and the bus bar are connected to each other by screw connection.

### CROSS-REFERENCE TO RELATED APPLICATIONS

The present application claims priority under 35 U.S.C. §119 to Japanese Patent Application No. 2013-237803, filed Nov. 18, 2013, entitled “Electricity Storage Module and Electricity Storage Cell.” The contents of this application are incorporated herein by reference in their entirety.

### BACKGROUND

1. Field

The present disclosure relates to an electricity storage module and an electricity storage cell.

2. Description of the Related Art

Japanese Unexamined Patent Application Publication No. 2010-176997 describes the following structure. That is, the positive and negative terminals of each pair of adjacent electricity storage cells in an electricity storage module are each provided with a male screw, and in a state in which two holes formed in a bus bar formed by a metal plate are fit onto the positive and negative terminals, a nut is brought into threaded engagement with each of the male screws, thereby electrically connecting the positive and negative terminals to each other via the bus bar.

### SUMMARY

According to one aspect of the present invention, an electricity storage module includes a plurality of electricity storage cells that are stacked together and each have a positive terminal and a negative terminal. The electricity storage cells includes at least one pair of adjacent electricity storage cells. The positive terminal of one of the at least one pair of adjacent electricity storage cells is electrically connected to another one of the at least one pair of adjacent electricity storage cells by a bus bar. The positive terminal and the negative terminal are made of different metals. Of the positive terminal and the negative terminal, one terminal and the bus bar are made of a same metal and connected to each other by welding. Another terminal and the bus bar are connected to each other by screw connection.

According to another aspect of the present invention, an electricity storage cell includes an electricity storage cell body. The electricity storage cell body includes a positive terminal and a negative terminal that are made of different metals. One of the positive terminal and the negative terminal has a main terminal that protrudes from a surface of the electricity storage cell body, and an auxiliary terminal that is welded to the main terminal at one end and has a bolt at another end.

According to further aspect of the present invention, an electricity storage module includes electricity storage cells. The electricity storage cells are stacked together and each have a positive terminal and a negative terminal. The electricity storage cells include a first electricity storage cell and a second electricity storage cell adjacent to the first electricity storage cell. The positive terminal of the first electricity storage cell is electrically connected to the negative terminal of the second electricity storage cell via a bus bar. The positive terminal and the negative terminal are made of different metals. One terminal and the bus bar are made of a same metal and connected to each other by welding. The one terminal is one of the positive terminal and the negative terminal. Another terminal and the bus bar are connected to each other by screw connection.

According to the other aspect of the present invention, an electricity storage cell includes an electricity storage cell body. The electricity storage cell body includes a positive terminal and a negative terminal made of different metals. One of the positive terminal and the negative terminal includes a main terminal and an auxiliary terminal. The main terminal protrudes from a surface of the electricity storage cell body. The auxiliary terminal is welded to the main terminal at one end and has a bolt at another end.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exploded perspective view of an electricity storage module;

FIG. 2 is a partial perspective view of the electricity storage module;

FIG. 3 is an exploded perspective view of a connected portion between a positive terminal and a negative terminal;

FIG. 4A is an enlarged cross-sectional view taken along a line IVA-IVA in FIG. 2; and

FIG. 4B is a view along an arrow IVB-IVB in FIG. 4A.

### DESCRIPTION OF THE EMBODIMENTS

The embodiments will now be described with reference to the accompanying drawings, wherein like reference numerals designate corresponding or identical elements throughout the various drawings.

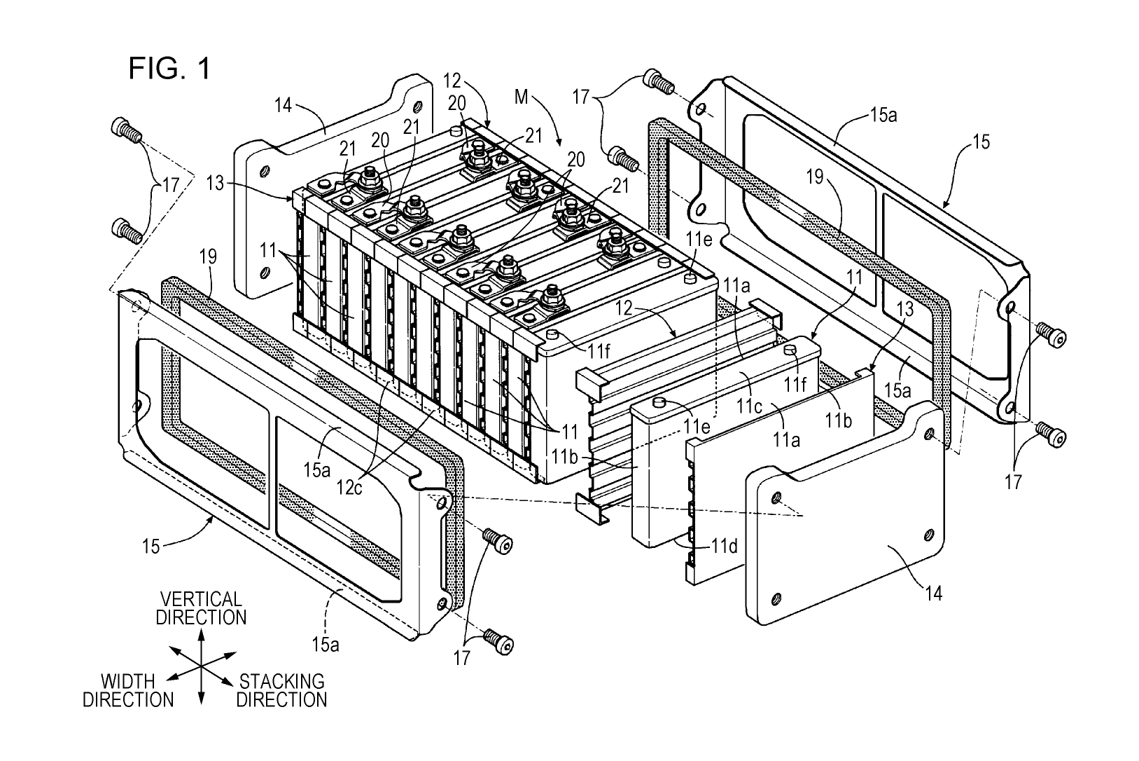

As illustrated in FIG. 1, an electricity storage module M used as a power supply for an electric vehicle or a hybrid vehicle includes a predetermined number of (twelve in the embodiment) electricity storage cells 11 that are stacked in the stacking direction. The electricity storage cells 11 according to the embodiment are lithium-ion cells. The electricity storage cells 11 have a rectangular parallelepiped shape. Each of the electricity storage cells 11 has a pair of principal surfaces 11a that are opposite to each other, a pair of side surfaces lib that are orthogonal to the principal surfaces 11a and are opposite to each other, and a top surface 11c and a bottom surface 11d that are orthogonal to the principal surfaces 11a and the side surfaces 11b and are opposite to each other. The top surface 11c is provided with a positive-side cell terminal 11e and a negative-side cell terminal 11f. The positive-side cell terminals 11e and the negative-side cell terminals 11f of the twelve electricity storage cells 11 are electrically connected in series.

In this specification, the direction perpendicular to the stacking direction and connecting the top surface 11c and the bottom surface 11d of each of the electricity storage cells 11 is defined as vertical direction, and the direction perpendicular to the stacking direction and connecting the pair of side surfaces 11b of each of the electricity storage cells 11 is defined as width direction.

The principal surfaces 11a of the twelve electricity storage cells 11, and eleven intermediate electricity-storage cell holders 12 made of synthetic resin and having a rectangular plate-like shape are alternately overlaid on each other in the stacking direction to form a stack. A pair of end electricity-storage cell holders 13 made of synthetic resin and having a rectangular plate-like shape are overlaid on the outside in the stacking direction of two electricity storage cells 11 located at opposite ends in the stacking direction of the stack. Further, a pair of end plates 14 made of metal are further overlaid on the outside in the stacking direction of the resulting stack.

In a state in which the electricity storage cells 11, the intermediate electricity-storage cell holders 12, the end electricity-storage cell holders 13, and the end plates 14 are stacked in the stacking direction, opposite end portions in the stacking direction of a pair of side fastening frames 15, which are formed by plate-like members made of metal, are fastened to opposite end portions in the width direction of the pair of end plates 14 with bolts 17, thereby assembling the electricity storage module M having the twelve electricity storage cells 11. At this time, insulators 19 made of synthetic resin are disposed between the electricity storage cells 11, the intermediate electricity-storage cell holders 12, the end electricity-storage cell holders 13, and the side fastening frames 15 to prevent liquid junction between the electricity storage cells 11 and the side fastening frames 15 due to dew condensation water.

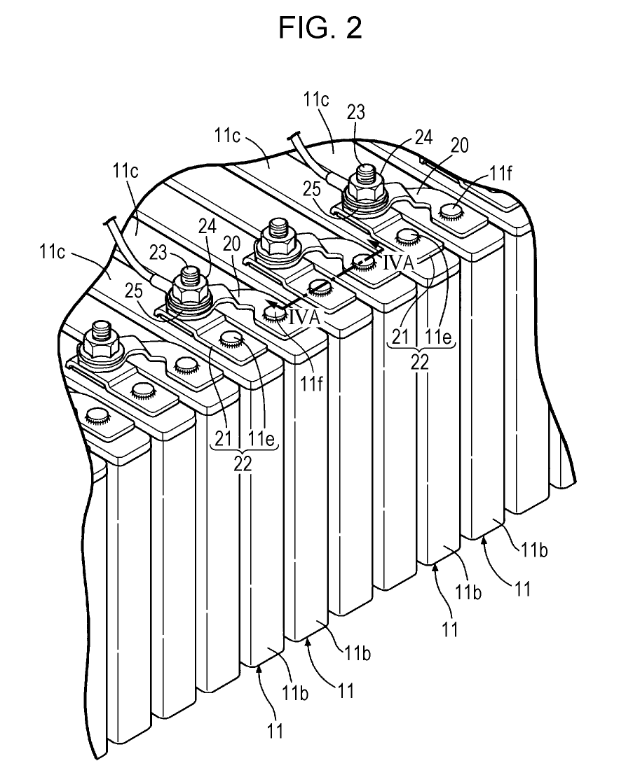

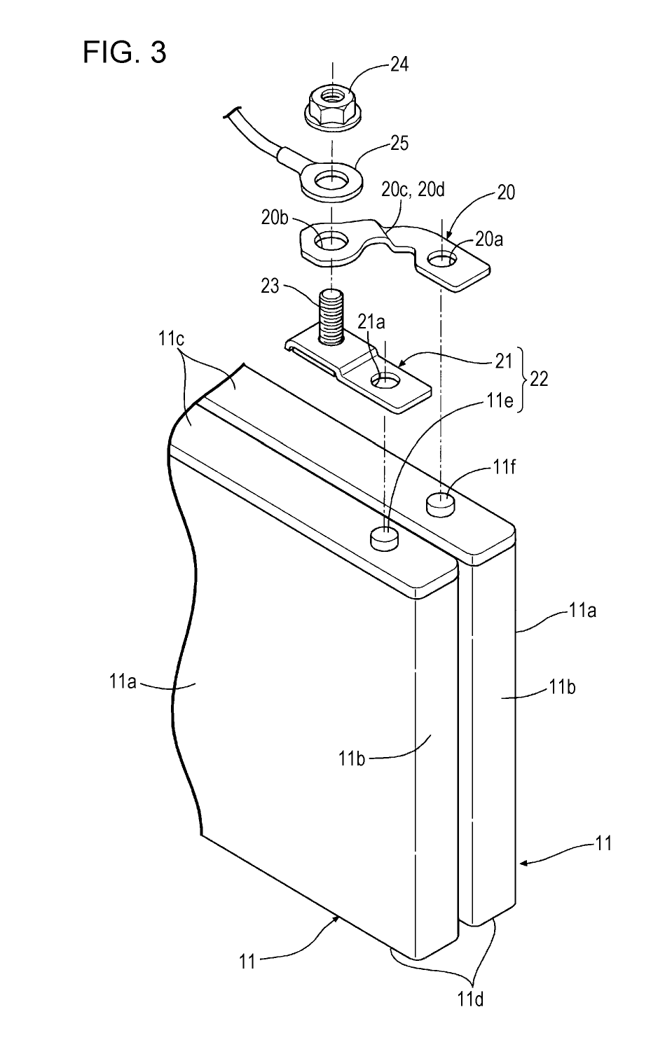

As illustrated in FIGS. 2 to 4B, each pair of adjacent electricity storage cells 11 are stacked in alternately opposite directions so that the positive-side cell terminal 11e and the negative-side cell terminal 11f are located close to each other. The positive-side cell terminal 11e and the negative-side cell terminal 11f are electrically connected to each other by a bus bar 20 and an auxiliary terminal 21. In each of the electricity storage cells 11 formed by lithium-ion cells, the positive-side cell terminal 11e is made of aluminum alloy, and the negative-side cell terminal 11f is made of copper alloy. The bus bar 20 is made of copper alloy, and the auxiliary terminal 21 is made of aluminum alloy.

The bus bar 20 is a plate-like member formed in an L-shape. A welding hole 20a having a circular shape is formed at one end of the bus bar 20, and a bolt hole 20b having a circular shape is formed at the other end. The middle portion of the bus bar 20 is bent in an L-shape. The middle portion has a narrow portion 20c with a smaller surface area, and a stepped portion 20d that is bent in the vertical direction so that the height of the bus bar 20 is lower on the welding hole 20a side and higher on the bolt hole 20b side. The negative-side cell terminal 11f forms the negative terminal of each of the electricity storage cells 11 by itself. The welding hole 20a of the bus bar 20 has the same diameter as the negative-side cell terminal 11f. The welding hole 20a fits onto the negative-side cell terminal 11f, and is secured to the negative-side cell terminal 11f by welding.

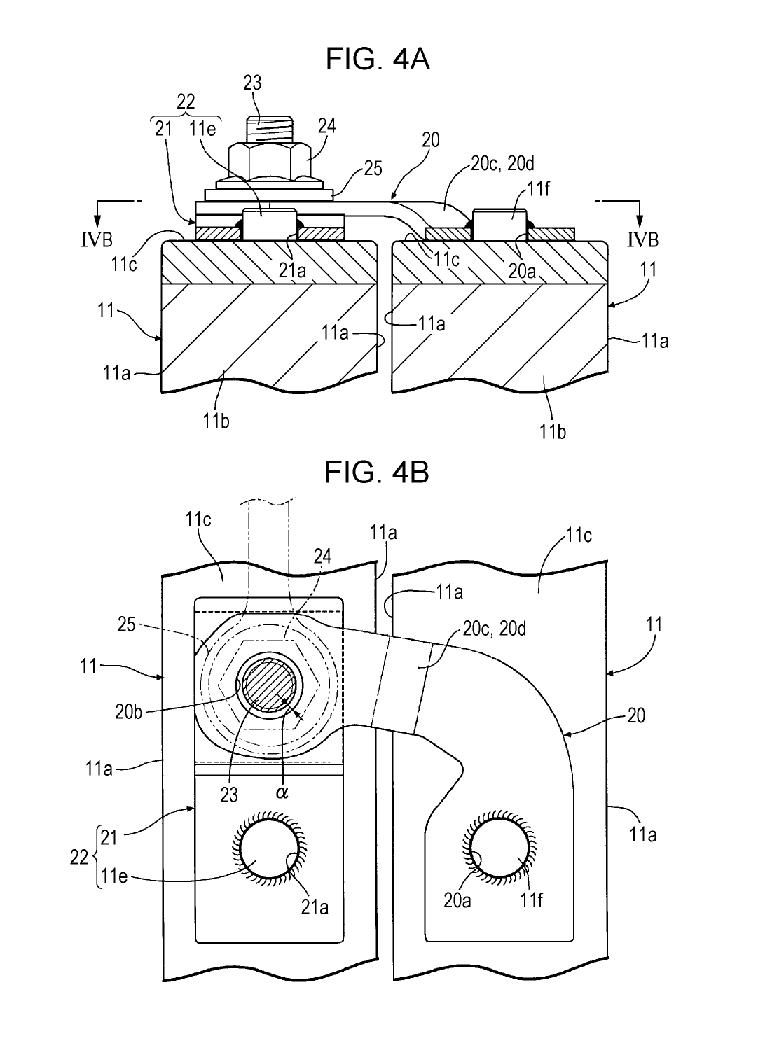

The auxiliary terminal 21 forms a positive terminal 22 of each of the electricity storage cells 11 in cooperation with the positive-side cell terminal 11e. The auxiliary terminal 21 is formed by a rectangular plate-like member made of aluminum alloy. A welding hole 21a having a circular shape is formed at one end of the auxiliary terminal 21, and a bolt 23 made of iron is secured to the other end by caulking. The welding hole 21a has the same diameter as the positive-side cell terminal 11e of each of the electricity storage cells 11. The welding hole 21a fits onto the positive-side cell terminal 11e, and is secured to the positive-side cell terminal 11e by welding. Further, the bolt hole 20b of the bus bar 20 has a radius that is set larger than the radius of the bolt 23 of the auxiliary terminal 21 by a (see FIG. 4B). By bringing a nut 24 into threaded engagement with the bolt 23 in a state in which the bolt hole 20b is fit onto the bolt 23, the bus bar 20 and the auxiliary terminal 21 are connected to each other. At this time, a voltage detection terminal 25 connected to a voltage sensor (not illustrated) is fastened together by the bolt 23 and the nut 24.

Next, operation according to the embodiment of the present disclosure configured as described above will be described.

After twelve electricity storage cells 11 are integrally fastened with the side fastening frames 15, the positive-side cell terminals lie and the negative-side cell terminals 11f of the electricity storage cells 11 are connected in series via the bus bars 20. First, in order to assemble the positive terminal 22, the welding hole 21a of the auxiliary terminal 21 made of aluminum alloy is fit and welded onto the positive-side cell terminal 11e made of aluminum alloy. Because this welding takes place between metals of the same kind, that is, aluminum alloys, the welding is easy, and the reliability of the weld is also ensured.

Next, the welding hole 20a of the bus bar 20 made of copper alloy is fit and welded onto the negative-side cell terminal 11f, which is made of copper alloy, of each of the electricity storage cells 11. Because this welding takes place between metals of the same kind, that is, copper alloys, the welding is easy, and the reliability of the weld is also ensured. At this time, the bolt hole 20b of the bus bar 20 fits onto the bolt 23 of the auxiliary terminal 21. Because the radius of the bolt hole 20b is set larger than the radius of the bolt 23 by a (see FIG. 4B), the bolt hole 20b and the bolt 23 may be made to fit each other easily even if there is an error in the relative position of the electricity storage cells 11. Then, lastly, after fitting the voltage detection terminal 25 onto the bolt 23, the nut 24 may be brought into threaded engagement with the bolt 23 to fasten the bus bar 20 and the voltage detection terminal 25 to the auxiliary terminal 21 together.

As described above, according to the embodiment, the negative-side cell terminal 11f and the bus bar 20 are both made of copper alloy and connected to each other by welding, and the positive-side cell terminal 11e and the auxiliary terminal 21 are both made of aluminum alloy and connected to each other by welding. Further, the bus bar 20 and the auxiliary terminal 21, which are made of different metals, are fastened by the bolt 23 and the nut 24, thereby minimizing the number of screw connections while eliminating welds between different metals to ensure reliability.

In particular, the positive terminal 22 includes the positive-side cell terminal 11e, and the auxiliary terminal 21 that is welded at one end to the positive-side cell terminal 11e, and the bus bar 20 is fastened by the nut 24 to the bolt 23 provided at the other end of the auxiliary terminal 21. Therefore, the bus bar 20 may be screw-connected to the positive-side cell terminal 11e that does not have the bolt 23, via the auxiliary terminal 21.

Furthermore, the voltage detection terminal 25 is fastened together by the bolt 23 and the nut 24. Therefore, no special component or welding is necessary to connect the voltage detection terminal 25, allowing further reduction of cost.

If there is a positional error between a pair of adjacent electricity storage cells 11, the bus bar 20 is deformed, potentially creating stress concentration which adversely affects durability. In this regard, the bus bar 20 is bent in an L-shape for easy flexibility, resulting in increased total length. Furthermore, the middle portion of the bus bar 20 is provided with the narrow portion 20c and the stepped portion 20d for further increased flexibility, thereby preventing a decrease in durability due to excessive load acting on the bus bar 20.

The negative-side cell terminal 11f has a cylindrical shape, and the welding hole 20a of the bus bar 20 which is fit and welded onto the negative-side cell terminal 11f has a circular shape. As a result, the clearance between the negative-side cell terminal 11f and the welding hole 20a of the bus bar 20 may be made small to ensure the reliability of welding. In this regard, if opposite end portions of the bus bar 20 are to be welded to the negative-side cell terminal 11f and the positive-side cell terminal 11e, it is difficult to make the above-mentioned clearance small owing to factors such as a positional error between the electricity storage cells 11. However, according to the embodiment, the bolt hole 20b of the bus bar 20 is connected to the auxiliary terminal 21 by means of screw connection. Therefore, the negative-side cell terminal 11f and the welding hole 20a of the bus bar 20 may be made to fit each other with a small clearance and welded together. Furthermore, the direction of screw connection between the bolt 23 and the nut 24 is the same as the axial direction of the negative-side cell terminal 11f. This prevents excessive torsional load from acting on the weld between the negative-side cell terminal 11f and the welding hole 20a at the time of screw connection, thus further increasing the reliability of the weld.

While the embodiment of the present disclosure has been described above, various design modifications may be made without departing from the scope of the present disclosure.

For example, the electricity storage cells 11 according to the present disclosure are not limited to lithium-ion cells.

The positive-side cell terminal 11e and the auxiliary terminal 21 may not necessarily be made of aluminum alloy as in the above-mentioned embodiment, and the negative-side cell terminal 11f and the bus bar 20 may not necessarily be made of copper alloy as in the above-mentioned embodiment, either.

In the above-mentioned embodiment, the auxiliary terminal 21 is provided on the positive terminal side, and the bus bar 20 is provided on the negative terminal (the negative-side cell terminal 11f) side. However, the auxiliary terminal 21 may be provided on the negative terminal side, and the bus bar 20 may be provided on the positive terminal side.

According to a first aspect of the present disclosure, there is proposed an electricity storage module including a plurality of electricity storage cells that are stacked together and each have a positive terminal and a negative terminal. The electricity storage cells include at least one pair of adjacent electricity storage cells, and the positive terminal of one of the at least one pair of adjacent electricity storage cells is electrically connected to another one of the at least one pair of adjacent electricity storage cells by a bus bar. The positive terminal and the negative terminal are made of different metals. Of the positive terminal and the negative terminal, one terminal and the bus bar are made of a same metal and connected to each other by welding, and another terminal and the bus bar are connected to each other by screw connection.

According to the configuration in the first aspect, the electricity storage module includes a plurality of electricity storage cells that are stacked together and each have a positive terminal and a negative terminal. The electricity storage cells include at least one pair of adjacent electricity storage cells, and the positive terminal of one of the at least one pair of adjacent electricity storage cells is electrically connected to another one of the at least one pair of adjacent electricity storage cells by a bus bar. The positive terminal and the negative terminal are made of different metals. Of the positive terminal and the negative terminal, one terminal and the bus bar are made of a same metal and connected to each other by welding, and another terminal and the bus bar are connected to each other by screw connection. Therefore, the one terminal and the bus bar, which are made of the same metal, are firmly connected to each other by welding, and the other terminal and the bus bar, which are made of different metals, are firmly connected to each other by screw connection, thereby reducing the number of screw connections while ensuring reliability.

According to a second aspect of the present disclosure, in addition to the configuration in the first aspect, the other terminal may include a main terminal that protrudes from a surface of each of the electricity storage cells, and an auxiliary terminal that is made of metal, the auxiliary terminal being welded to the main terminal at one end and having a bolt at another end, and the bus bar may be fastened to the bolt by a nut.

According to the configuration in the second aspect, the other terminal may include a main terminal that protrudes from the surface of each of the electricity storage cells, and an auxiliary terminal that is made of metal, the auxiliary terminal being welded to the main terminal at one end and having a bolt at another end, and the bus bar may be fastened to the bolt by a nut. As a result, the bus bar may be screw-connected to the main terminal that does not have the bolt, via the auxiliary terminal.

According to a third aspect of the present disclosure, in addition to the configuration in the second aspect, a voltage detection terminal may be fastened together by the bolt and the nut.

According to the configuration in the third aspect, a voltage detection terminal may be fastened together by the bolt and the nut. Therefore, no special component or welding is necessary to connect the voltage detection terminal, allowing further reduction of cost.

According to a fourth aspect of the present disclosure, in addition to the configuration in the second or third aspect, the other terminal may be the positive terminal, the main terminal and the auxiliary terminal of the positive terminal may be each made of aluminum alloy, and the negative terminal and the bus bar may be each made of copper alloy.

According to the configuration in the fourth aspect, the other terminal may be the positive terminal, the main terminal and the auxiliary terminal of the positive terminal may be each made of aluminum alloy, and the negative terminal and the bus bar may be each made of copper alloy. Because the main and auxiliary terminals of the positive terminal are made of the same material, their welding is easy. Because the negative terminal and the bus bar are made of the same material, their welding is easy.

According to a fifth aspect of the present disclosure, in addition to the configuration in any one of the first to fourth aspects, the bus bar has a narrow portion in a middle portion of the bus bar.

According to the configuration in the fifth aspect, the bus bar has a narrow portion in the middle portion of the bus bar. As a result, even if there is an error in relative position between the positive and negative terminals connected to the bus bar, the narrow portion of the bus bar is easily flexible, allowing the error in relative position to be absorbed.

According to a sixth aspect of the present disclosure, in addition to the configuration in any one of the first to fifth aspects, the bus bar may have a stepped portion in a middle portion of the bus bar, the stepped portion being a portion where the bus bar changes in height in a vertical direction.

According to the configuration in the sixth aspect, the bus bar may have a stepped portion in the middle portion of the bus bar, the stepped portion being a portion where the bus bar changes in height in the vertical direction. As a result, even if there is an error in relative position between the positive and negative terminals connected to the bus bar, the stepped portion of the bus bar is easily flexible, allowing the error in relative position to be absorbed.

According to a seventh aspect of the present disclosure, in addition to the configuration in the fifth or sixth aspect, the bus bar may be bent in an L-shape in the middle portion when viewed in a vertical direction.

According to the configuration in the seventh aspect, the bus bar may be bent in an L-shape in the middle portion when viewed in the vertical direction. As a result, the total length of the bus bar may be increased and flexibility may be further improved.

According to an eighth aspect of the present disclosure, in addition to the configuration in any one of the first to seventh aspects, the one terminal may include a cylindrical terminal, the bus bar may include a welding hole that has a circular shape, the welding hole being fit and welded onto the cylindrical terminal, and the screw connection may be made in a same direction as an axial direction of the cylindrical terminal.

According to the configuration in the eighth aspect, the one terminal may include a cylindrical terminal, the bus bar may include a welding hole that has a circular shape, the welding hole being fit and welded onto the cylindrical terminal. As a result, the clearance between the cylindrical terminal and the circular welding hole may be made small to ensure the reliability of welding. If opposite ends of the bus bar are to be welded to the positive terminal and the negative terminal, it is difficult to make the above-mentioned clearance small owing to factors such as a positional error between the electricity storage cells. However, because the connection at the other end of the bus bar is by screw connection, the cylindrical terminal and the circular welding hole may be made to fit each other with a small clearance and welded together. Furthermore, the direction of the screw connection is the same as the axial direction of the cylindrical terminal. This prevents excessive torsional load from acting on the weld at the time of screw connection, thus further increasing the reliability of the weld.

According to a ninth aspect of the present disclosure, there is proposed an electricity storage cell including an electricity storage cell body having a positive terminal and a negative terminal that are made of different metals. One of the positive terminal and the negative terminal has a main terminal that protrudes from a surface of the electricity storage cell body, and an auxiliary terminal that is welded to the main terminal at one end and has a bolt at another end.

According to the configuration in the ninth aspect, the electricity storage cell includes an electricity storage cell body having a positive terminal and a negative terminal that are made of different metals. One of the positive terminal and the negative terminal may have a main terminal that protrudes from the surface of the electricity storage cell body, and an auxiliary terminal that is welded to the main terminal at one end and has a bolt at another end. Therefore, when making an electrical connection between the positive terminal of one of each pair of adjacent electricity storage cells and the negative terminal of the other electricity storage cell by the bus bar, the one terminal and the bus bar, which are made of different metals, are firmly connected to each other by screw connection, and the other terminal and the bus bar, which are made of the same metal, are firmly connected to each other by welding, thereby minimizing the number of screw connections while ensuring reliability.

The positive-side cell terminal 11e according to the embodiment corresponds to the main terminal according to the present disclosure, and the negative-side cell terminal 11f according to the embodiment corresponds to the negative terminal according to the present disclosure.

Obviously, numerous modifications and variations of the present invention are possible in light of the above teachings. It is therefore to be understood that within the scope of the appended claims, the invention may be practiced otherwise than as specifically described herein.

What is claimed is:

1. An electricity storage module comprising:
a plurality of electricity storage cells that are stacked together and each have a positive terminal and a negative terminal, the electricity storage cells comprising at least one pair of adjacent electricity storage cells, the positive terminal of one of the at least one pair of adjacent electricity storage cells being electrically connected to another one of the at least one pair of adjacent electricity storage cells by a bus bar,
wherein the positive terminal and the negative terminal are made of different metals, and of the positive terminal and the negative terminal, one terminal and the bus bar are made of a same metal and connected to each other by welding, and another terminal and the bus bar are connected to each other by screw connection.

2. The electricity storage module according to claim 1, wherein:
the other terminal includes
a main terminal that protrudes from a surface of each of the electricity storage cells, and
an auxiliary terminal that is made of metal, the auxiliary terminal being welded to the main terminal at one end and having a bolt at another end; and
the bus bar is fastened to the bolt by a nut.

3. The electricity storage module according to claim 2, wherein a voltage detection terminal is fastened together by the bolt and the nut.

4. The electricity storage module according to claim 2, wherein:
the other terminal is the positive terminal;
the main terminal and the auxiliary terminal of the positive terminal are each made of aluminum alloy; and
the negative terminal and the bus bar are each made of copper alloy.

5. The electricity storage module according to claim 1, wherein the bus bar has a narrow portion in a middle portion of the bus bar.

6. The electricity storage module according to claim 1, wherein the bus bar has a stepped portion in a middle portion of the bus bar, the stepped portion being a portion where the bus bar changes in height in a vertical direction.

7. The electricity storage module according to claim 5, wherein the bus bar is bent in an L-shape in the middle portion when viewed in a vertical direction.

8. The electricity storage module according to claim 1, wherein:
the one terminal comprises a cylindrical terminal;
the bus bar includes a welding hole that has a circular shape, the welding hole being fit and welded onto the cylindrical terminal; and
the screw connection is made in a same direction as an axial direction of the cylindrical terminal.

9. An electricity storage cell comprising:
an electricity storage cell body, the electricity storage cell body including a positive terminal and a negative terminal that are made of different metals,
wherein one of the positive terminal and the negative terminal has
a main terminal that protrudes from a surface of the electricity storage cell body, and
an auxiliary terminal that is welded to the main terminal at one end and has a bolt at another end.

10. An electricity storage module comprising:
electricity storage cells stacked together and each having a positive terminal and a negative terminal, the electricity storage cells including a first electricity storage cell and a second electricity storage cell adjacent to the first electricity storage cell, the positive terminal of the first electricity storage cell being electrically connected to the negative terminal of the second electricity storage cell via a bus bar, the positive terminal and the negative terminal being made of different metals, one terminal and the bus bar being made of a same metal and connected to each other by welding, the one terminal being one of the positive terminal and the negative terminal, and another terminal and the bus bar being connected to each other by screw connection.

11. The electricity storage module according to claim 10, wherein:
the another terminal includes
a main terminal that protrudes from a surface of each of the electricity storage cells, and
an auxiliary terminal that is made of metal, the auxiliary terminal being welded to the main terminal at one end and having a bolt at another end; and
the bus bar is fastened to the bolt via a nut.

12. The electricity storage module according to claim 11, wherein a voltage detection terminal is fastened to the bolt together with the bus bar via the nut.

13. The electricity storage module according to claim 11, wherein:
the another terminal is the positive terminal;
the main terminal and the auxiliary terminal of the positive terminal are each made of aluminum alloy; and
the negative terminal and the bus bar are each made of copper alloy.

14. The electricity storage module according to claims 10, wherein the bus bar has a narrow portion in a middle portion of the bus bar.

15. The electricity storage module according to claim 10, wherein the bus bar has a stepped portion in a middle portion of the bus bar, the stepped portion being a portion where the bus bar changes in height in a vertical direction.

16. The electricity storage module according to claim 14, wherein the bus bar is bent in an L-shape in the middle portion when viewed in a vertical direction.

17. The electricity storage module according to claim 10, wherein:
the one terminal comprises a cylindrical terminal;
the bus bar includes a welding hole that has a circular shape, the welding hole being fit and welded onto the cylindrical terminal; and
the screw connection is made in a same direction as an axial direction of the cylindrical terminal.

18. An electricity storage cell comprising:
an electricity storage cell body including a positive terminal and a negative terminal made of different metals, one of the positive terminal and the negative terminal comprising:
a main terminal protruding from a surface of the electricity storage cell body; and
an auxiliary terminal welded to the main terminal at one end and having a bolt at another end.

19. The electricity storage module according to claim 10,
wherein the first and second electricity storage cells are stacked in alternately opposite directions so that the positive terminal of the first electricity storage cell and the negative terminal of the second electricity storage cell are located close to each other.
